(19) United States
(12) Patent Application Publication
(10) Pub. No.: US 2016/0370483 A1
(43) Pub. Date: Dec. 22, 2016

(54) SYSTEM AND METHOD FOR CORRECTING DATA AFTER COMPONENT REPLACEMENT IN PERMANENT SEISMIC MONITORING WITH CONTINUOUS SEISMIC RECORDING

(71) Applicant: CGG SERVICES SA, Massy (FR)

(72) Inventors: Julien COTTON, Paris (FR); Eric FORGUES, Bures-sur-Yvette (FR); Cecile BERRON, Massy (FR)

(21) Appl. No.: 15/122,281

(22) PCT Filed: Mar. 3, 2015
(86) PCT No.: PCT/IB2015/000502

§ 371 Date: Aug. 29, 2016

Related U.S. Application Data
(60) Provisional application No. 61/948,423, filed on Mar. 5, 2014.

(51) Int. Cl. G01V 1/36; G01V 1/30

(52) U.S. Cl. CPC G01V 1/36; G01V 1/308; G01V 2210/57

(57) ABSTRACT

A system and method for correcting data after component replacement in continuous seismic exploration disclosed. The method includes calculating a first matching operator after a first component is replaced with a second component. The first matching operator is based on a first seismic trace recorded before replacement of the first component and a second seismic trace recorded after replacement of the first component. The method further includes correcting the second seismic trace by applying the first matching operator to the second seismic trace.

### CROSS-REFERENCE TO RELATED APPLICATION

This application claims the benefit under 35 U.S.C. §119(e) of U.S. Provisional Application Ser. No. 61/948,423 filed on Mar. 5, 2014, which is incorporated by reference in its entirety for all purposes.

### TECHNICAL FIELD

The present disclosure relates generally to seismic exploration tools and processes and, more particularly, to a system and method for correcting data after component replacement in permanent seismic monitoring with continuous seismic recording.

### BACKGROUND

In the oil and gas industry, geophysical survey techniques are commonly used to aid in the search for and evaluation of subterranean hydrocarbon or other mineral deposits. Generally, a seismic energy source, or “source,” generates a seismic signal that propagates into the earth and is partially reflected by subsurface seismic interfaces between underground formations having different acoustic impedances. Seismic detectors, or “receivers,” located at or near the surface of the earth, in a body of water, or at known depths in boreholes, record the reflections and the resulting seismic data can be processed to yield information relating to the location and physical properties of the subsurface formations. Seismic data acquisition and processing generates a profile, or image, of the geophysical structure under the earth's surface. While this profile does not provide an accurate location for oil and gas reservoirs, it suggests, to those trained in the field, the presence or absence of them.

The seismic signal is emitted in the form of a wave that is reflected off interfaces between geological layers. When the wave encounters an interface between different media in the earth's subsurface a portion of the wave is reflected back to the earth's surface while the remainder of the wave is refracted through the interface. The reflected waves are received by an array of geophones, or receivers, located at the earth's surface, which convert the displacement of the ground resulting from the propagation of the waves into an electrical signal recorded by means of recording equipment. The receivers typically record data during the source's sweep interval and during a subsequent “listening” interval. The receivers record the time at which each reflected wave is received. The travel time from source to receiver, along with the velocity of the source wave, can be used to reconstruct the path of the waves to create an image of the subsurface.

The receivers detect the reflected signals and record them in the form of a seismic trace or data. Typically one trace is recorded per receiver, per survey. A plurality of traces from multiple receivers are then compiled into records to complete the survey. Records are processed to present the data in suitable form for use by geophysicists for determining the properties and structures of subterranean earth formations. A large amount of data may be recorded by the receivers and the recorded signals may be subjected to signal processing to improve the quality of the data before the data is ready for interpretation. The recorded seismic data may be processed to yield information relating to the location of the subsurface reflectors and the physical properties of the subsurface formations. That information is then used to generate an image of the subsurface. In interpreting or processing data recorded in seismic traces, it is useful if the traces are evenly spaced and sufficiently close together in order to create repeatable, linear data.

Two methods of reservoir monitoring are in common use today, continuous seismic monitoring and 4D seismic monitoring; both methods involve multiple sources and receivers that are in use for an extended period of time. In continuous seismic monitoring, sources and receivers may continually operate for months or years to monitor changes in a reservoir or other subsurface formation. In 4D seismic monitoring, also called “time-lapse monitoring,” sources and receivers repeat a seismic survey over a defined time interval. Each survey can be performed hours, days, weeks, or months apart. 4D seismic monitoring also monitors changes in a reservoir or other subsurface formation.

In a typical continuous seismic monitoring or 4D seismic monitoring survey, a first survey is performed and serves as the baseline survey. Follow-on surveys are then performed at the same location at pre-defined intervals. The sources and receivers remain the same and are placed in the same location in each survey to remove any data variability due to equipment characteristics or location. However, if a follow-on survey does not closely repeat the conditions of a previous survey, survey matching techniques may be used to reduce or eliminate the variability between surveys due to changes in the environmental conditions at the survey location between surveys, changes in the noise energy between surveys, changes in the location of the survey equipment, and any other variable that may affect the repeatability of the survey data. Differences between the baseline survey and the follow-on survey, after survey variability has been reduced or eliminated via survey matching techniques, can be caused by changes in the earth's subsurface. Therefore, the images between the baseline survey and follow-on surveys can be compared to determine the change of the subsurface layers or target reservoir. As such, typical time-lapse surveys attempt to match survey data acquisition parameters and equipment with what was used in the baseline survey as closely as possible to remove/control those variables in order to compute a valid difference image that measures changes in target properties and not changes in equipment.

As described above, in continuous seismic monitoring and 4D seismic monitoring, where sources and receivers are in use for months or years, occasionally a source or receiver may become inoperable, damaged, malfunctioning, or may otherwise need to be replaced. In some cases, the replacement source or receiver may not be placed in the same location as the inoperable source or receiver. In other cases, the replacement source or receiver may have different characteristics, such as signature, sensitivity, noise characteristics, or other characteristic, than the inoperable source or receiver. The signature of a source is the aspect of a wave shape generated by the source, which makes it distinctive and distinguishes a particular source from other sources. Further, the replacement source or receiver may not be replaced at the same time the first source or receiver becomes inoperable, thus some data may be missing until the source or receiver is replaced. The differences between the placement and characteristics of the first source or receiver and the replacement source or receiver can impact the repeatability of the data from the seismic monitoring and prevent an accurate image of the change in the subsurface layers. Missing data can cause bias in data processing results.

### SUMMARY

In accordance with one embodiment of the present disclosure, a method of correcting data after component replacement in seismic exploration is disclosed. The method includes calculating a first matching operator after a first component is replaced with a second component. The first matching operator is based on a first seismic trace recorded before replacement of the first component and a second seismic trace recorded after replacement of the first component. The method further includes correcting the second seismic trace by applying the first matching operator to the second seismic trace.

In accordance with another embodiment of the present disclosure, a seismic exploration system is disclosed. The system includes a seismic source configured to emit a seismic signal into a subsurface geology. The system also includes a seismic receiver configured to receive energy from the seismic source that is reflected off the subsurface geology. The system further includes a unit communicatively coupled to the seismic receiver and configured to record received energy. When a first component is replaced with a second component, the unit is further configured to calculate a first matching operator. The first matching operator is based on a first seismic trace recorded before replacement of the first component and a second seismic trace recorded after replacement of the first component. The unit is also configured to correct the second seismic trace by applying the first matching operator to the second seismic trace.

In accordance with further embodiments of the present disclosure, a non-transitory computer-readable medium is disclosed. The non-transitory computer-readable medium includes computer-executable instructions carried on the computer-readable medium. The instructions, when executed after a first component is replaced with a second component, cause a processor to calculate a first matching operator. The first matching operator is based on a first seismic trace recorded before replacement of the first component and a second seismic trace recorded after replacement of the first component. The instructions also cause a processor to correct the second seismic trace by applying the first matching operator to the second seismic trace.

### BRIEF DESCRIPTION OF THE DRAWINGS

For a more complete understanding of the present invention and its features and advantages, reference is now made to the following description, taken in conjunction with the accompanying drawings, in which like reference numbers indicate like features and wherein:

FIG. 1 illustrates a seismic exploration system including a source and a receiver in accordance with some embodiments of the present disclosure;

FIG. 2 illustrates a graph of the records of reflected signals obtained with the system of FIG. 1 in accordance with some embodiments of the present disclosure;

FIG. 3 illustrates a graph of the trace of reflected signals recorded by the system of FIG. 1 with a correction applied to traces occurring after a source is replaced in accordance with some embodiments of the present disclosure;

FIG. 4 illustrates a graph of the traces of reflected signals recorded by the system of FIG. 1 including an interpolation of a missing trace in accordance with some embodiments of the present disclosure;

FIG. 5 illustrates a flow chart of an example method for correcting and interpolating data after replacing a component in seismic exploration in accordance with some embodiments of the present disclosure; and

FIG. 6 illustrates an elevation view of an example seismic exploration system configured to produce images of the earth's subsurface geological structure in accordance with some embodiments of the present disclosure.

### DETAILED DESCRIPTION

Seismic monitoring methods such as continuous seismic monitoring and 4D seismic monitoring operate over an extended period of time. Occasionally components of the system, such as a source or a receiver, become inoperable, damaged, malfunctioning, or may otherwise need to be replaced. Therefore, according to the teachings of the present disclosure, systems and methods are presented that correct data to account for differences between the first component and the second, replacement component. Additionally, systems and methods are presented that interpolate data to fill gaps in recorded data where there is a lack of data due to the time required to replace a component. Correcting data after replacing a component may preserve repeatability among data recorded during a seismic monitoring survey. Unlike survey matching techniques, the systems and methods disclosed apply to the data generated by a replaced component and not to an entire seismic survey dataset. Interpolating data after replacing a component may prevent a lack of data for data processing and reduces potential bias caused by gaps in recorded data.

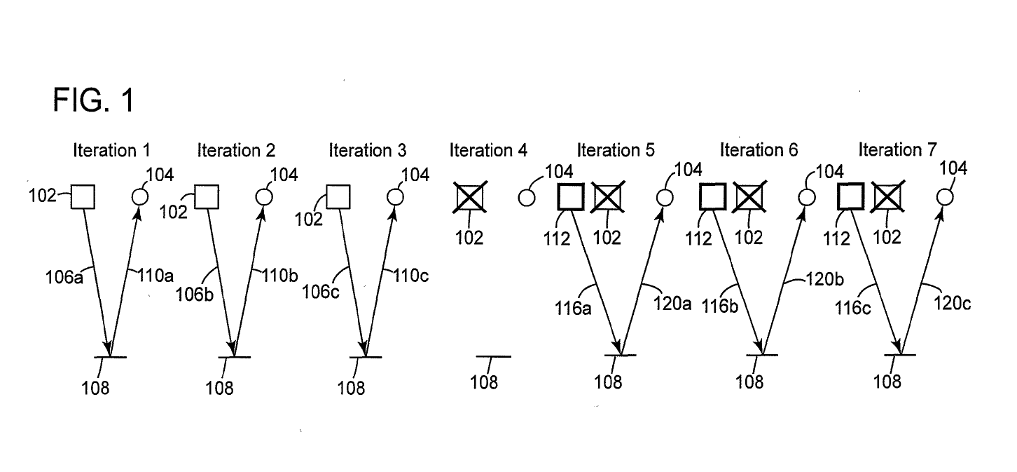

As an example of a seismic monitoring system where a component is replaced, FIG. 1 illustrates a seismic exploration system including a source and a receiver in accordance with some embodiments of the present disclosure. FIG. 1 illustrates one exemplary embodiment with first source 102 and receiver 104. In FIG. 1, first source 102 emits a seismic signal at each iteration 1 through 7. At iteration 1, first source 102 emits signal 106a, which is reflected off a subsurface formation 108. Receiver 104 receives reflected signal 110a. At iterations 2 and 3, first source 102 emits signals 106b and 106c, respectively. Emitted signals 106a, 106b, and 106c may be collectively referred to as “emitted signals 106.” Receiver 104 receives reflected signals 110a, 110b and 110c, respectively. At some time between iteration 3 and iteration 4, first source 102 fails to operate. Therefore, at iteration 4, first source 102 does not emit a signal and receiver 104 does not receive a reflected signal. At some time before iteration 5, first source 102 is replaced with second source 112. Second source 112 is located near first source 102, but not in the same location. Second source 112 may have a different signature from first source 102, for example second source 112 may emit a different wave shape than the wave shape emitted by first source 102. At iteration 5, second source 112 emits signal 116a and receiver 104 receives reflected signal 120a. At iterations 6 and 7, second source 112 emits signals 116b and 116c, respectively and receiver 104 receives reflected signals 120b and 120c, respectively. Emitted signals 116a, 116b, and 116c may be collectively referred to as “emitted signals 116.”

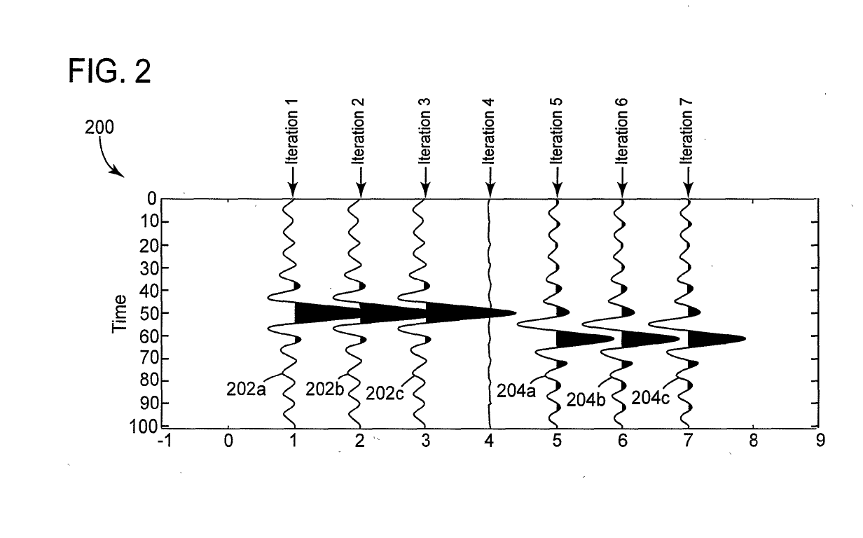

As described with respect to FIG. 1, receiver 104 receives reflected signals 110a, 110b, 110c from first seismic source 102. Next receiver 104 receives reflected signals 120a, 120b, and 120c from second seismic source 112. Reflected signals 110 and 120 may be reflected waves, direct waves, refracted waves, or a combination of waves including noise waves. Reflected signals 110 and 120 may be compiled into records. FIG. 2 illustrates graph 200 of the records of reflected signals obtained with the system of FIG. 1 in accordance with some embodiments of the present disclosure. The illustration in FIG. 2 may represent, in the time domain, a correlated wavelet obtained from a vibrating source emitting a signal including a frequency sweep, a wavelet obtained from an impulsive source, a reconstructed wavelet obtained by gathering multiple mono-frequency emissions, or a wavelet from a single mono-frequency emission. The records may be referred to as “seismic traces” or simply “traces.” A trace represents the response of the signal to velocity and density contrasts across interfaces of layers of rock or sediments as energy travels from a source through the subsurface to a receiver. A trace is recorded over a period of time. In FIG. 2, the y-axis of graph 200 represents the elapsed time (t) of the listening interval of each iteration. When first source 102, as shown in FIG. 1, emits signal 106a, receiver 104 records reflected signal 110a as trace 202a. Reflected signals 110b and 110c from iterations 2 and 3, respectively, are recorded as traces 202b and 202c, respectively. At iteration 4, because first source 102 fails to emit a signal as discussed with reference to FIG. 1, receiver 104 does not receive a reflected signal and thus no trace is recorded. First source 102 is then replaced with second source 112, as described with respect to FIG. 1. At iteration 5, receiver 104 receives reflected signal 120a, which is recorded as trace 204a. As can be seen in FIG. 2, the data between trace 202c and trace 204a is not aligned. Thus, the seismic data is not repeatable. Repeatability is desired in continuous seismic monitoring and 4D seismic monitoring in order monitor the changes in the reservoir without introducing variability due to changes in the monitoring equipment, such as first source 102, second source 112, or receiver 104. This lack of repeatability may be caused by a change in the location of second source 112 compared to first source 102 or by the different signature of second source 112. A correction may be applied to data generated by second source 112 to allow for data repeatability. Thereby, trace 204a, trace 204b, and trace 204c can be corrected.

In some embodiments, traces recorded after a component is replaced may be corrected through the use of a matching operator. For example, a matching operator may be computed by dividing data recorded immediately after the component replacement by data recorded immediately before the component replacement. Each trace is a function of time. For the example embodiment illustrated in FIG. 1 and FIG. 2, a matching operator, OP, may be calculated using a well-known spectral division (using all traces or a subset of the traces in a specified time window:

$$OP = \frac{FT ( 204 a )}{FT ( 202 a )} \qquad ( 1 a )$$

where FT is the Fourier transform that can be approximated by a fast Fourier transform (“FFT”). The spectral division may be stabilized to avoid a zero division. In seismic processing, spectral division stabilization may be performed by adding white noise.

The average seismic traces related to a common calendar period may be summed before and after the component replacement to improve the signal to noise ratio. The summation may be obtained by using the following formulas for the mean, median, and weighted average which are also referred to as the “diversity stack.”

$$\begin{matrix}OP = \frac{FT ( mean ( 204 a , 204 b , 204 c ) )}{FT ( mean ( 202 a , 202 b , 202 c ) )} & ( 1 b ) \\ OP = \frac{FT ( median ( 204 a , 204 b , 204 c ) )}{FT ( median ( 202 a , 202 b , 202 c ) )} & ( 1 c ) \\ OP = \frac{FT ( weighted mean ( 204 a , 204 b , 204 c ) )}{FT ( weighted mean ( 202 a , 202 b , 202 c ) )} & ( 1 d )\end{matrix}$$

Equations 1a, 1b, 1c, and 1d may be performed in phase and amplitude for each frequency, however in some embodiments, Equations 1a, 1b, 1c, and 1d may be performed in phase only or in amplitude only.

In other cases, the spectral division may not be needed and a simple division may be performed to match the amplitudes. In such cases, the matching operator, OP, may be a scalar:

$$OP = \frac{rms ( 204 a )}{rms ( 202 c )} \qquad ( 1 e )$$

The matching operator may be calculated for varied aspects of data in a seismic trace, including phase, amplitude, frequency, or any other suitable parameter. Other mathematical functions may be utilized in calculating the matching operator such as any function that accounts for differences between two traces due to component location or characteristic. Additionally, the traces used to calculate the matching operator may not be the traces recorded immediately before and after the component replacement. However, if the traces used are not the traces recorded immediately before and after the component replacement, the signal to noise ratio may be increased.

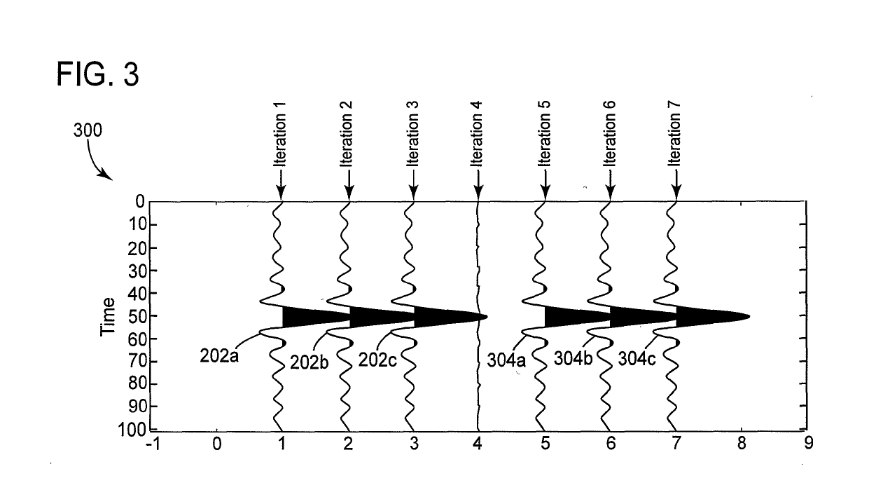

Once the matching operator, OP, is known, trace 204a, trace 204b, and trace 204c may be corrected. FIG. 3 illustrates a graph 300 of the trace of reflected signals recorded by the system of FIG. 1 with a correction applied to traces occurring after first source 102 is replaced with second source 112 in accordance with some embodiments of the present disclosure. Traces occurring after first source 102 is replaced with second source 112 are corrected by dividing the trace by the matching operator. For example, trace 304a is the corrected trace 204a of reflected signal 120a, as shown with respect to FIG. 1. In the case of spectral division, as described with respect to Equations 1a-1d, trace 304a is calculated by:

$$304 a = IFT ( \frac{FT ( 204 a )}{OP} ) \qquad ( 2 a )$$

where IFT is the inverse Fourier transform that may be approximated with an inverse fast Fourier transform (“IFFT”). In the case of simple division, as described with respect to Equation 1e, trace 304a is calculated by:

$$304 a = \frac{204 a}{OP} \qquad ( 2 b )$$

Trace 304b is the corrected version of trace 204b and trace 304c is the corrected version of trace 204c, as shown with respect to FIG. 2. While FIG. 3 illustrates only three corrected traces, the matching operator may be used to correct any suitable number of traces occurring after component replacement. The matching operator can be used to correct data in both the time domain and the Fourier domain. In the Fourier domain the traces and the resulting matching operator are a function of frequency instead of time as described in Equations 1a-1e and 2a-2b.

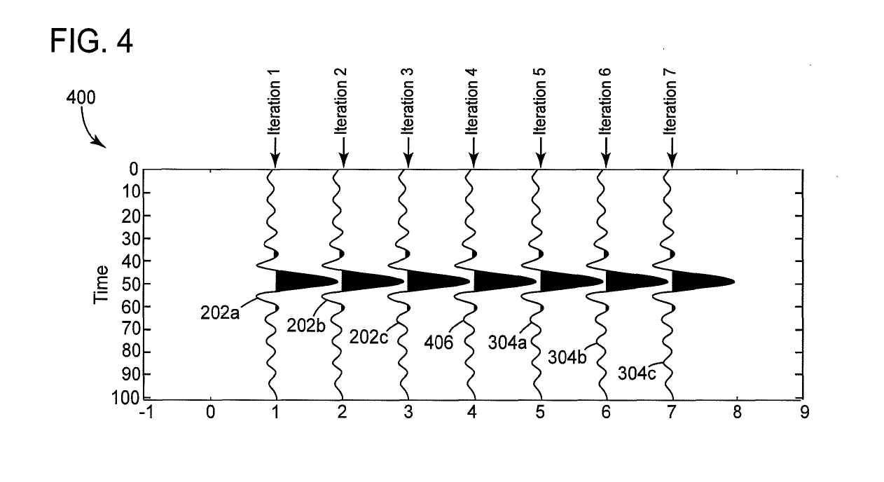

There may also be gaps in data caused by a delay in replacing components. For example, in FIG. 1, at iteration 4, first source 102 had not yet been replaced by second source 112 thus no signal was emitted and no data was recorded for that iteration. Gaps in data may cause data processing issues such as bias or nonlinearity. Any gaps in data caused by a delay in replacing components may be estimated through interpolation techniques. FIG. 4 illustrates graph 400 of the traces of reflected signals recorded by the system of FIG. 1 including an interpolation of a missing trace in accordance with some embodiments of the present disclosure. For example, the missing trace may have occurred at iteration 4, as discussed with respect to FIG. 1. The missing trace may be interpolated by linear interpolation, nonlinear interpolation, or any other suitable complex signal processing interpolation technique using either one channel (including 2D interpolation using a single source-receiver pair in the calendar time, also called “iterations”) or multiple channels (including 4D interpolation using plural source-receiver pairs in the calendar time, also called “iterations”). In the embodiment shown in FIG. 4, the missing trace, trace 406, is created via linear interpolation. More specifically, trace 406 is calculated as:

$$406 = IFT ( \frac{FT ( 202 c ) + \frac{FT ( 304 a )}{OP}}{2} ) \qquad ( 3 )$$

While the example embodiment discussed in FIGS. 1-4 illustrates the replacement of a source, a matching operator can be used to correct data or interpolate missing data due to the replacement of a receiver.

The matching operator may also be used to correct data after a first replacement component is replaced by a second replacement component. In such cases, the matching operator may be calculated by dividing a trace recorded after installation of the second replacement component by a trace recorded before replacement of the first replacement component. The matching operator may also be calculated by dividing a trace recorded after installation of the second replacement component by a trace recorded before replacement of the first component.

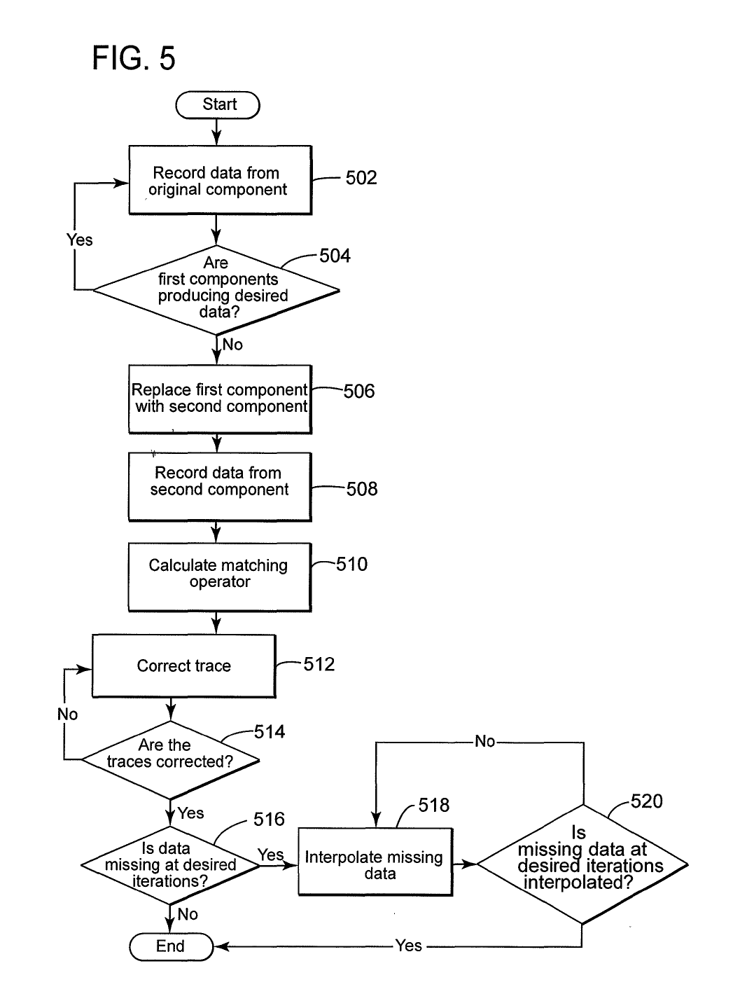

FIG. 5 illustrates a flow chart of example method 500 for correcting and interpolating data after replacing a component in seismic exploration in accordance with some embodiments of the present disclosure. Data correction after the replacement of a component enhances repeatability among data recorded during a seismic monitoring survey. Data interpolation after the replacement of a component prevents a lack of data for data processing and reduces potential data processing errors caused by gaps in recorded data.

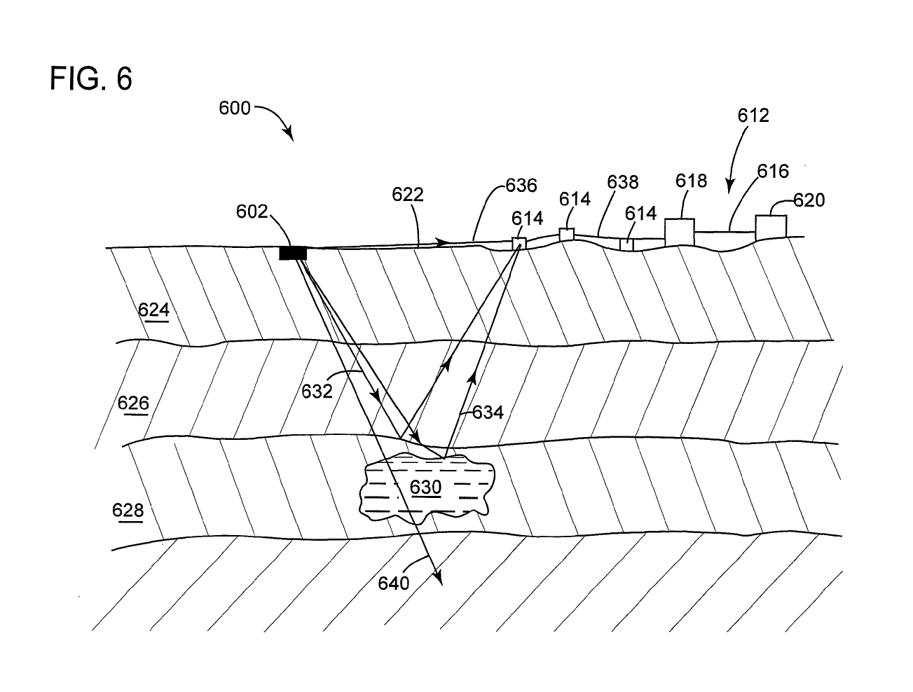

The method 500 begins at step 502, where data from a first component in a seismic array used for continuous seismic monitoring or 4D seismic monitoring is recorded. The data recorded in step 502 may be reflected signals 110a, 110b, or 110c, as shown in FIG. 1 and may be recorded as traces 202a, 202b, or 202c, as shown in FIG. 2. Reflected signals may be received by a receiver and recorded by a recording unit, as discussed further with respect to FIG. 6.

In step 504, a determination is made as to whether all first components are operable. If all first components are in the desired working order, method 500 returns to step 502, as illustrated by iteration 2 and iteration 3, as shown with respect to FIG. 1. If all first components are not operable, method 500 proceeds to step 506.

In step 506, the first component is replaced by a second component. The first or second component can be a source or a receiver. For example, in the embodiment shown in FIG. 1, source 102 is replaced by source 112.

In step 508, data from the second, replacement component is recorded. The data recorded in step 506 may be reflected signals 120a-c, as shown in FIG. 1 and may be recorded as traces 204, as shown in FIG. 2.

In step 510, a matching operator is calculated. For example, the matching operator may be calculated by dividing the trace recorded immediately after the first component is replaced with the second component by the trace recorded immediately before the first component is replaced with the second component. As discussed with respect to FIG. 2, the matching operator is calculated using any of Equations 1a-1e.

In step 512, a trace recorded after the first component was replaced with the second component is corrected, such as any trace recorded in step 508. The trace may be corrected by applying the matching operator calculated in step 510. For example, the trace may be corrected using any of Equations 2a-2b.

In step 514, a determination is made as to whether a suitable number of traces recorded after the first component was replaced with the second component, such as traces recorded in step 508, have been corrected. For example, as discussed with respect to FIG. 2, a determination may be made if traces 204a, 204b, and 204c have been corrected. If traces recorded after the first component was replaced with the second component have been corrected, method 500 proceeds to step 516, otherwise method 500 returns to step 512 to correct the next trace.

In step 516, a determination is made as to whether any trace data is missing. Data may be missing if a delay greater than the interval between the traces occurred between when the first component became inoperable and when the first component was replaced by a second component in step 506. For example, with respect to FIG. 2, data is missing at iteration 4. If data is missing, method 500 proceeds to step 518. If no data is missing, method 500 is complete.

In step 518, the missing data is interpolated. The missing trace may be interpolated by linear interpolation, nonlinear interpolation, or any other suitable complex signal processing interpolation technique. For example, the missing data shown in FIG. 4 between trace 202c and 304a is interpolated by using linear interpolation techniques as shown in Equation 3.

In step 520, a determination is made as to whether all missing data has been interpolated. If all missing data has been interpolated, method 500 is complete. If all missing data has not been interpolated, method 500 returns to step 518 to interpolate the next missing trace.

Once method 500 is complete, the data recorded from the first component, the corrected data recorded from the second component, and interpolated data may be processed using suitable seismic data processing techniques or used in any other suitable method of using seismic trace data. Method 500 discusses the replacement of a first component. However, during seismic monitoring, a second component may also become inoperable. The steps of method 500 may be used to correct data recorded after a first second component is replaced with a second second component, as described with respect to FIG. 4.

The steps of method 500 can be performed by a user, various computer programs, models, or any combination thereof, configured to simulate, design, or process data from a seismic exploration signal systems, apparatuses, or devices. The programs and models may include instructions stored on a computer-readable medium and operable to perform, when executed, one or more of the steps described above. The computer-readable media can include any system, apparatus, or device configured to store and retrieve programs or instructions such as a hard disk drive, a compact disc, flash memory, or any other suitable device. The programs and models may be configured to direct a processor or other suitable unit to retrieve and execute the instructions from the computer-readable media. Collectively, the user or computer programs and models used to simulate, design, or process data from a seismic exploration systems may be referred to as a “seismic data tool.”

Modifications, additions, or omissions may be made to method 500 without departing from the scope of the present disclosure. For example, the order of the steps may be performed in a different manner than that described and some steps may be performed at the same time. For example, step 516 may be performed before step 512. Additionally, each individual step may include additional steps without departing from the scope of the present disclosure. Further, more steps may be added or steps may be removed without departing from the scope of the disclosure.

The method described with reference to FIG. 5 is used to enhance the effectiveness of a system used to emit seismic signals, receive reflected signals, and process the resulting data to image the earth's subsurface. FIG. 6 illustrates an elevation view of an example seismic exploration system 600 configured to produce images of the earth's subsurface geological structure in accordance with some embodiments of the present disclosure. The images produced by system 600 allow for the evaluation of subsurface geology. System 600 may include one or more seismic energy sources 602 and one or more receivers 614 which are located within a pre-determined exploration area. The exploration area may be any defined area selected for seismic survey or exploration. Survey of the exploration area may include the activation of seismic source 602 that radiates an acoustic wave field that expands downwardly through the layers beneath the earth's surface. The seismic wave field is then partially reflected from the respective layers as a wave front recorded by receivers 614. For example, source 602 generates seismic waves and receivers 614 record rays 632 and 634 reflected by interfaces between subsurface layers 624, 626, and 628, oil and gas reservoirs, such as target reservoir 630, or other subsurface structures. Subsurface layers 624, 626, and 628 may have various densities, thicknesses, or other characteristics. Target reservoir 630 may be separated from surface 622 by multiple layers 624, 626, and 628. As the embodiment depicted in FIG. 6 is exemplary only, there may be more or fewer layers 624, 626, or 628 or target reservoirs 630. Similarly, there may be more or fewer rays 632 and 634. Additionally, some source waves may not be reflected, as illustrated by ray 640.

Seismic energy source 602 may be referred to as an acoustic source, seismic source, energy source, and source 602. In some embodiments, source 602 is located on or proximate to surface 622 of the earth within an exploration area. A particular source 602 may be spaced apart from other similar sources. Source 602 may be operated by a central controller that coordinates the operation of several sources 602. Further, a positioning system, such as a global positioning system (GPS), may be utilized to locate and time-correlate sources 602 and receivers 614. Multiple sources 602 may be used to improve testing efficiency, provide greater azimuthal diversity, improve the signal to noise ratio, or improve spatial sampling. The use of multiple sources 602 may also input a stronger signal into the ground than a single, independent source 602. First source 102 and second source 112, as discussed in FIG. 1, may be source 602 and the component replaced in step 506, as discussed in FIG. 5, may be source 602.

Source 602 may comprise any type of seismic device that generates controlled seismic energy used to perform reflection or refraction seismic surveys, such as a seismic vibrator, vibroseis, dynamite, an air gun, a thumper truck, or any other suitable seismic energy source. Source 602 may radiate seismic energy into surface 622 and subsurface formations during a defined interval of time. Source 602 may impart energy through a sweep of multiple frequencies or at a single monofrequency, or through a combination of at least one sweep and at least one monofrequency.

Seismic exploration system 600 may include monitoring device 612 that operates to record reflected energy rays 632, 634, and 636. Monitoring device 612 may include one or more receivers 614, network 616, recording unit 618, and processing unit 620. In some embodiments, monitoring device 612 may be located remotely from source 602.

Receiver 614 may be located on or proximate to surface 622 of the earth within an exploration area. Receiver 614 may be any type of instrument that is operable to transform seismic energy or vibrations into a voltage signal. For example, receiver 614 may be a vertical, horizontal, or multicomponent geophone, accelerometers, or optical fiber with wire or wireless data transmission, such as a three component (3C) geophone, a 3C accelerometer, or a 3C Digital Sensor Unit (DSU). Multiple receivers 614 may be utilized within an exploration area to provide data related to multiple locations and distances from sources 602. Receivers 614 may be positioned in multiple configurations, such as linear, grid, array, or any other suitable configuration. In some embodiments, receivers 614 may be positioned along one or more strings 638. Each receiver 614 is typically spaced apart from adjacent receivers 614 in the string 638. Spacing between receivers 614 in string 638 may be approximately the same preselected distance, or span, or the spacing may vary depending on a particular application, exploration area topology, or any other suitable parameter. For example, receiver 104, from FIG. 1, or the replaced component in step 506, as discussed in FIG. 5, may be receiver 614.

One or more receivers 614 transmit raw seismic data from reflected seismic energy, such as reflected signal 110 from FIG. 1, via network 616 to recording unit 618. Recording unit 618 transmits raw seismic data to processing unit 620 via network 616. Processing unit 620 performs seismic data processing on the raw seismic data to prepare the data for interpretation. For example, processing unit 620 may perform the calculation of the matching operator, calculation of the corrected traces, and interpolation of the missing traces, as described in FIG. 2, FIG. 3, and FIG. 4 as well as method 500. Although discussed separately, recording unit 618 and processing unit 620 may be configured as separate units or as a single unit. Recording unit 618 or processing unit 620 may include any instrumentality or aggregation of instrumentalities operable to compute, classify, process, transmit, receive, store, display, record, or utilize any form of information, intelligence, or data. For example, recording unit 618 and processing unit 620 may include one or more personal computers, storage devices, servers, or any other suitable device and may vary in size, shape, performance, functionality, and price. Recording unit 618 and processing unit 620 may include random access memory (RAM), one or more processing resources, such as a central processing unit (CPU) or hardware or software control logic, or other types of volatile or non-volatile memory. Additional components of recording unit 618 and processing unit 620 may include one or more disk drives, one or more network ports for communicating with external devices, one or more input/output (I/O) devices, such as a keyboard, a mouse, or a video display. Recording unit 618 or processing unit 620 may be located in a station truck or any other suitable enclosure.

Network 616 may be configured to communicatively couple one or more components of monitoring device 612 with any other component of monitoring device 612. For example, network 616 may communicatively couple receivers 614 with recording unit 618 and processing unit 620. Further, network 614 may communicatively couple a particular receiver 614 with other receivers 614. Network 614 may be any type of network that provides communication, such as one or more of a wireless network, a local area network (LAN), or a wide area network (WAN), such as the Internet.

The seismic survey may be repeated at various time intervals to determine changes in target reservoir 630. The time intervals may be months or years apart as discussed by the intervals illustrated in FIG. 1. Data may be collected and organized based on offset distances, such as the distance between a particular source 602 and a particular receiver 614 and the amount of time it takes for rays 632 and 634 from a source 602 to reach a particular receiver 614. Data collected during a survey by receivers 614 may be reflected in traces that may be gathered, processed, and utilized to generate a model of the subsurface structure or variations of the structure, for example continuous seismic monitoring or 4D seismic monitoring, for example traces 202 and 204 as discussed in FIG. 2.

Although discussed with reference to a land implementation, embodiments of the present disclosure are also useful in sea bed applications. In a seabed acquisition application, where receiver 614 is placed on the seabed, monitoring device 612 may include 3C geophone and hydrophones.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. For example, the emitted signals 106 and 116 in FIG. 1 may be any combination of seismic sweeps and monofrequencies. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. For example, a receiver does not have to be turned on but must be configured to receive reflected energy.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. The computer processor may serve as a seismic data tool as described in method 500 in FIG. 5.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer-readable storage medium or any type of media suitable for storing electronic instructions, and coupled to a computer system bus. Furthermore, any computing systems referred to in the specification may include a single processor or may be architectures employing multiple processor designs for increased computing capability. For example, the seismic data tool described in method 500 with respect to FIG. 5 may be stored in tangible computer-readable storage media.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims. Moreover, while the present disclosure has been described with respect to various embodiments, it is fully expected that the teachings of the present disclosure may be combined in a single embodiment as appropriate. Instead, the scope of the invention is defined by the appended claims.

What is claimed is:

1. A method of correcting datasets after component replacement in permanent seismic monitoring, comprising:
calculating a first matching operator after a first component is replaced with a second component, the first matching operator is based on a first seismic trace recorded before replacement of the first component and a second seismic trace recorded after replacement of the first component; and
correcting the second seismic trace by applying the first matching operator to the second seismic trace.

2. The method of claim 1, wherein the first component is a seismic source.

3. The method of claim 1, wherein the first component is a seismic receiver.

4. The method of claim 1, further comprising interpolating a missing seismic trace based on the first seismic trace and the second seismic trace.

5. The method of claim 1, further comprising calculating a second matching operator after the second component is replaced with a third component, the second matching operator is based on a third seismic trace recorded before replacement of the second component and a fourth seismic trace recorded after replacement of the second component.

6. The method of claim 1, wherein calculating the first matching operator includes:
averaging, in calendar time, the first seismic trace; and
averaging, in calendar time, the second seismic trace.

7. The method of claim 1, wherein the first seismic trace includes a plurality of seismic traces recorded before replacement of the first component and the second seismic trace includes a plurality of seismic traces recorded after replacement of the first component.

8. The method of claim 1, wherein the first or second seismic trace includes a plurality of seismic traces received by a plurality of seismic receivers.

9. A permanent seismic monitoring system comprising:
a seismic source configured to emit a seismic signal into a subsurface geology;
a seismic receiver configured to receive energy from the seismic source reflected off of the subsurface geology; and
a unit communicatively coupled to the seismic receiver, the unit configured to record received energy; the unit further configured to, when a first component is replaced with a second component:
calculate a first matching operator, the first matching operator is based on a first seismic trace recorded before replacement of the first component and a second seismic trace recorded after replacement of the first component; and
correct the second seismic trace by applying the first matching operator to the second seismic trace.

10. The seismic exploration system of claim 9, wherein the first component is the seismic source.

11. The seismic exploration system of claim 9, wherein the first component is the seismic receiver.

12. The seismic exploration system of claim 9, the unit further configured to interpolate a missing seismic trace based on the first seismic trace and the second seismic trace.

13. The seismic exploration system of claim 9, the unit further configured to calculate a second matching operator after the second component is replaced with a third component, the second matching operator is based on a third seismic trace recorded before replacement of the second component and a fourth seismic trace recorded after replacement of the second component.

14. The seismic exploration system of claim 9, wherein calculating the first matching operator includes:
averaging, in calendar time, the first seismic trace; and
averaging, in calendar time, the second seismic trace.

15. The seismic exploration system of claim 9, wherein the first seismic trace includes a plurality of seismic traces recorded after replacement of the first component and the second seismic trace includes a plurality of seismic traces recorded before replacement of the first component.

16. A non-transitory computer-readable medium, comprising:
computer-executable instructions carried on the computer-readable medium, the instructions, when executed after a first component is replaced with a second component, causing a processor to:
calculate a first matching operator, the first matching operator is based on a first seismic trace recorded before replacement of the first component and a second seismic trace recorded after replacement of the first component; and
correct the second seismic trace by applying the first matching operator to the second seismic trace.

17. The non-transitory computer-readable medium of claim 16, wherein the first component is a seismic source.

18. The non-transitory computer-readable medium of claim 16, wherein the first component is a seismic receiver.

19. The non-transitory computer-readable medium of claim 16, the processor further configured to interpolate a missing seismic trace based on the first seismic trace and the second seismic trace.

20. The non-transitory computer-readable medium of claim 16, the processor further configured to calculate a second matching operator after the second component is replaced with a third component, the second matching operator is based on a third seismic trace recorded before replacement of the second component and a fourth seismic trace recorded after replacement of the second component.
